(19) United States
(12) Patent Application Publication
(10) Pub. No.: US 2025/0272751 A1
(43) Pub. Date: Aug. 28, 2025

(54) RELATIONAL DATABASE MANAGEMENT SYSTEMS OF DATA STRUCTURES FACILITATING FILE MANAGEMENT AND DATA RETRIEVAL

(71) Applicant: Truist Bank, Charlotte, NC (US)

(72) Inventor: Laura Paige DeWispelare, Cookeville, TN (US)

(73) Assignee: Truist Bank, Charlotte, NC (US)

(21) Appl. No.: 18/585,291

(22) Filed: Feb. 23, 2024

(51) Int. Cl. G06Q 40/04; G06Q 20/40

(52) U.S. Cl. CPC G06Q 40/04; G06Q 20/401

(57) ABSTRACT

Systems and methods receive input(s) to access an interface to facilitate a resource conversion from a first resource of one regional entity to a second resource of foreign regional entity(ies), the entity platform incorporating information of relational database(s), and display of an ordering interface is initiated to order the second resource. A selection input of a specific foreign regional entity is received, and stored current exchange rate data are accessed from relational database(s) that indicate a present exchange rate between the first resource and the second resource. Display of the present exchange rate and control input(s) is initiated for specifying a quantity of the second resource to be exchanged and for indicating a general regional location where the second resource is to be retrieved. An indication of the quantity of the second resource to be exchanged and the general regional location for retrieval of the second resource is received.

### FIELD OF THE INVENTION

This invention relates generally to the field of relational database management systems, and more particularly embodiments of the invention relate to relational database management systems of data structures facilitating file management and data retrieval.

### BACKGROUND OF THE INVENTION

Relational database management systems are programs that enable creation, administration, and management of relational databases. Relational databases organize data points with defined relationships into specialized formats that include data structures. The relational database management systems can facilitate file management and data retrieval that can be used to perform various software processes. Business entities utilize relational database management systems to keep track of inventory levels, customer information, shipping, orders, etc., which can automate and organize many entity systems. In order to improve customer experience, entities strive to provide relevant information to customers that will help customers best utilize their time and resources in order to perform various necessary tasks. However, existing systems and methods used by entities to provide customers with a satisfying customer experience are not always available for various customer needs.

Thus, a need exists for improved systems and methods for providing customers with an improved customer experience that will help customers best utilize their time and resources.

### BRIEF SUMMARY

Shortcomings of the prior art are overcome and additional advantages are provided through the provision of a relational database management system of data structures facilitating file management and data retrieval. The system includes at least one processor, a communication interface communicatively coupled to the at least one processor, and a memory device storing executable code. When the executable code is executed, it causes the at least one processor to, at least in part, receive, across a network via an entity platform from a computing device, one or more inputs to access an interface to facilitate a resource conversion from a first resource of one regional entity to a second resource of one or more foreign regional entities, the entity platform incorporating information of one or more relational database. Further, display, via the entity platform on a user interface of the computing device, an ordering interface to order the second resource of the one or more foreign regional entities is initiated, and a selection input of a specific foreign regional entity of the one or more foreign regional entities is received. Based thereon stored current exchange rate data are accessed from the one or more relational databases, the stored current exchange rate data indicating a present exchange rate between the first resource of the one regional entity and the second resource of the specific foreign regional entity. Display, via the entity platform on the user interface of the computing device, the present exchange rate and one or more control inputs is initiated for (a) specifying a quantity of the second resource to be exchanged from the first resource of the one regional entity to the second resource of the specific foreign regional entity, and (b) indicating a general regional location where the second resource of the specific foreign regional entity is to be retrieved. An indication of the quantity of the second resource to be exchanged and the general regional location where the second resource of the specific foreign regional entity is to be retrieved are received via the one or more control inputs. Data processing is performed on resource data that indicate on-hand resource quantities of the second resource of the specific foreign regional entity at a plurality of entity pickup locations, and processing times are ascertained for the quantity of the second resource to be exchanged to be transported to targeted pickup locations of the plurality of entity pickup locations that are within the general regional location where the second resource of the specific foreign regional entity is to be retrieved. A list of the targeted pickup locations where the second resource of the specific foreign regional entity can be retrieved and a corresponding earliest available time when the second resource of the specific foreign regional entity would be available for retrieval at each of the targeted pickup locations are generated and display thereof is initiated, where the corresponding earliest available time is based on the on-hand resource quantities and the ascertained processing times. An order input is received from the computing device that indicates a pickup location from the list of the targeted pickup locations where the quantity of the second resource to be exchanged is to be picked up

Additionally, disclosed herein is a computing system for data retrieval. The system includes at least one processor, a communication interface communicatively coupled to the at least one processor, and a memory device storing executable code that, when executed, causes the at least one processor to, at least in part, transmit, across a network via an entity platform, one or more control signals to an entity system from a computing device, the one or more control signals requesting access an interface to facilitate a resource conversion from a first resource of one regional entity to a second resource of one or more foreign regional entities, the entity platform incorporating information of one or more relational databases. One or more responses are received by the computing device from the entity system, and based thereon an ordering interface is displayed on a user interface to order the second resource of the one or more foreign regional entities. A selection input indicating a specific foreign regional entity of the one or more foreign regional entities displayed by the ordering interface is processed and based thereon selection data of the specific foreign regional entity is transmitted by the computing device to the entity system. A present exchange rate and one or more control inputs are received from the entity system and displayed via the user interface of the computing device for (a) specifying a quantity of the second resource to be exchanged from the first resource of the one regional entity to the second resource of the specific foreign regional entity, and (b) indicating a general regional location where the second resource of the specific foreign regional entity is to be retrieved. An indication of the quantity of the second resource to be exchanged and the general regional location where the second resource of the specific foreign regional entity is to be retrieved are received via the one or more control inputs and transmitted to the entity system. A GPS system of the computing device is used to ascertain a current geolocation of the computing device and transmit current geolocation data of the current geolocation to the entity system. Targeted pickup location data are received and a list of targeted pickup locations where the second resource of the specific foreign regional entity can be received and a corresponding earliest available time when the second resource of the specific foreign regional entity would be available for retrieval at each of the targeted pickup locations are displayed via the user interface, where the corresponding earliest available time is based on on-hand resource quantities and processing times. An order input indicating a pickup location from the list of targeted pickup locations where the quantity of the second resource to be exchanged is to be picked up is received via the user interface and transmitted to the entity system.

Also disclosed herein is a computer-implemented method that includes, at least in part, receiving, across a network via an entity platform from a computing device, one or more inputs to access an interface to facilitate a resource conversion from a first resource of one regional entity to a second resource of one or more foreign regional entities, the entity platform incorporating information of one or more relational databases. The method also includes initiating display, via the entity platform on a user interface of the computing device, of an ordering interface to order the second resource of the one or more foreign regional entities. The method also includes receiving a selection input of a specific foreign regional entity of the one or more foreign regional entities, and based thereon access stored current exchange rate data from the one or more relational databases, the stored current exchange rate data indicating a present exchange rate between the first resource of the one regional entity and the second resource of the specific foreign regional entity. Display, via the entity platform on the user interface of the computing device, is initiated of the present exchange rate and one or more control inputs for (a) specifying a quantity of the second resource to be exchanged from the first resource of the one regional entity to the second resource of the specific foreign regional entity, and (b) indicating a general regional location where the second resource of the specific foreign regional entity is to be retrieved. The method further includes performing data processing on resource data that indicate on-hand resource quantities of the second resource of the specific foreign regional entity at a plurality of entity pickup locations, and ascertaining processing times for the quantity of the second resource to be exchanged to be transported to targeted pickup locations of the plurality of entity pickup locations that are within the general regional location where the second resource of the specific foreign regional entity is to be retrieved. In addition, the method generates and initiates display, via the entity platform on the user interface of the computing device, of a list of the targeted pickup locations where the second resource of the specific foreign regional entity can be retrieved and a corresponding earliest available time when the second resource of the specific foreign regional entity would be available for retrieval at each of the targeted pickup locations, the corresponding earliest available time being based on the on-hand resource quantities and the ascertained processing times. An order input indicating a pickup location from the list of the targeted pickup locations where the quantity of the second resource to be exchanged is to be picked up is received from the computing device.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

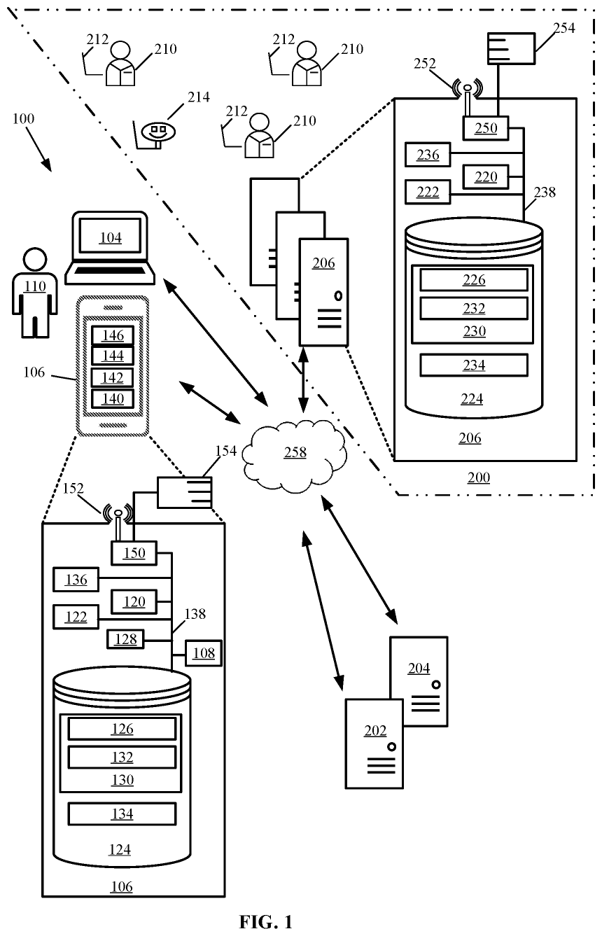

FIG. 1 illustrates an example computing environment of a relational database management system, in accordance with an embodiment of the present invention;

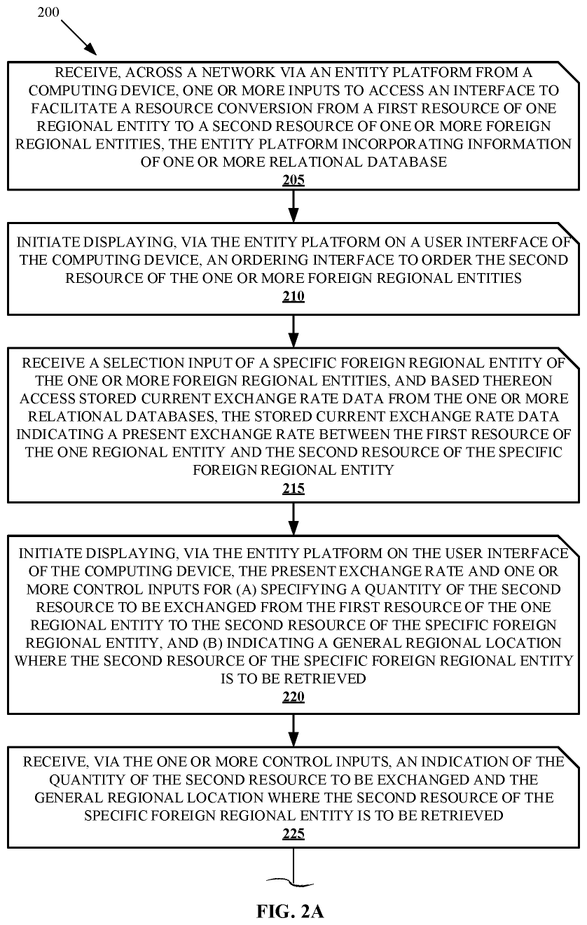

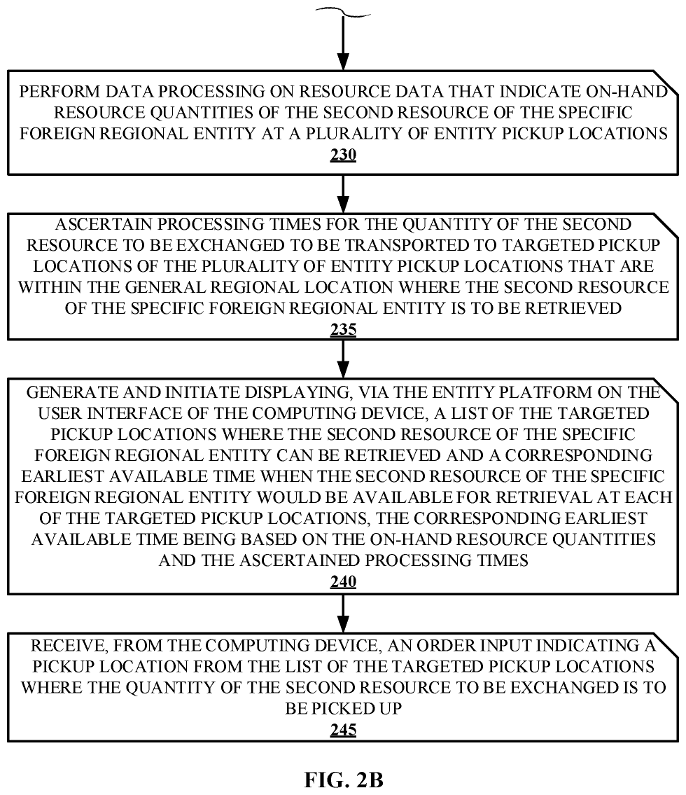

FIG. 2A depicts a block diagram of an example method to facilitate a resource conversion from a first resource of one regional entity to a second resource of one or more foreign regional entities, in accordance with an embodiment of the present invention;

FIG. 2B depicts additional elements of the example method of FIG. 2A, in accordance with an embodiment of the present invention;

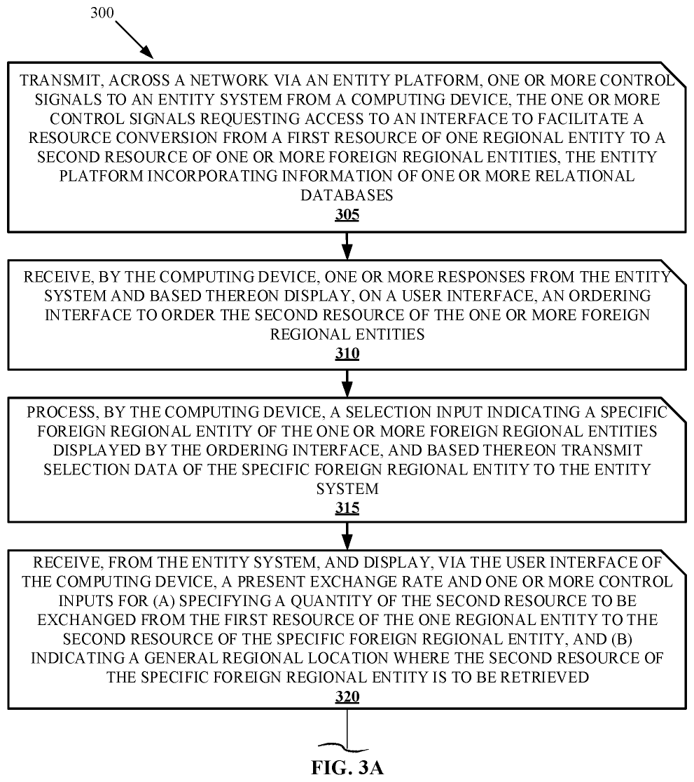

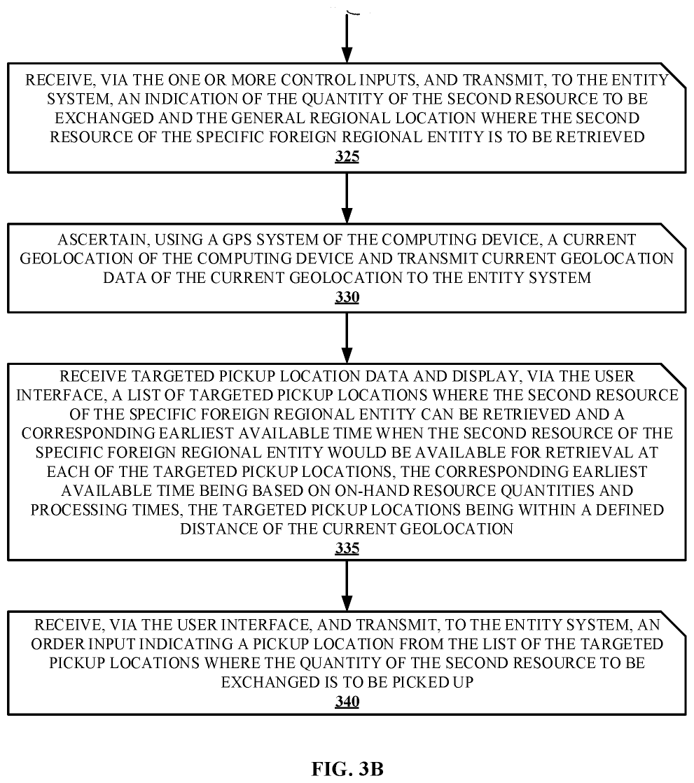

FIG. 3A depicts a block diagram of an example method to facilitate a resource conversion from a first resource of one regional entity to a second resource of one or more foreign regional entities, in accordance with an embodiment of the present invention; and

FIG. 3B depicts additional elements of the example method of FIG. 3A, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

Like numbers refer to like elements throughout. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “couple,” “coupled,” “couples,” “coupling,” “fixed,” “attached to”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi- permanent or only for an instant. “Communicatively coupled to” and “operatively coupled to” can refer to physically and/or electrically related components.

In addition, as used herein, the terms “about”, “approximately”, or “substantially” for any numerical values or ranges indicate a suitable dimensional tolerance that allows the device, part, or collection of components to function for its intended purpose as described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

As used herein, the terms “enterprise” or “provider” generally describes a person or business enterprise that hosts, maintains, or uses computer systems that provide functionality for the disclosed systems and methods. In particular, the term “enterprise” may generally describe a person or business enterprise providing goods or services. Interactions between an enterprise system and a user device can be implemented as an interaction between a computing system of the enterprise, and a user device of a user. For instance, user(s) may provide various inputs that can be interpreted and analyzed using processing systems of the user device and/or processing systems of the enterprise system. Further, the enterprise computing system and the user device may be in communication via a network. According to various embodiments, the enterprise system and/or user device(s) may also be in communication with another external or third-party server of a third party system that may be used to perform one or more server operations. In some embodiments, the functions of one illustrated system or server may be provided by multiple systems, servers, or computing devices, including those physically located at a central computer processing facility and/or those physically located at remote locations.

Embodiments of the present invention are described herein, with reference to flowchart illustrations and/or block diagrams of computer-implemented methods and computing systems according to embodiments of the invention. Each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus or apparatuses (the term “apparatus” includes systems and computer program products). In particular, the computer readable program instructions, which be executed via the processor of the computer or other programmable data processing apparatus, create a means for implementing the functions/acts specified in the flowchart and/or block diagram block or blocks.

In one embodiment, these computer readable program instructions may also be stored in one or more computer-readable storage media that can direct a computer or other programmable data processing apparatus, and/or other devices, to function in a particular manger, such that a computer readable storage medium of the one or more computer-readable storage media having instructions stored therein comprises an article of manufacture including instructions which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block or blocks.

In another embodiment, these computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions, whether stored in the computer-readable storage medium and/or computer-readable memory may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable instructions for implementing the specified logical function(s). Additionally, the alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, or the functions of the blocks may sometimes be executed in the reverse order, depending upon the functionality involved.

FIG. 1 illustrates a computing environment 100 that facilitates relational database management, according to at least one embodiment of the present invention. The computing environment 100 generally includes a user 110 (e.g., an employee of an enterprise) that benefits through use of services and products offered by the enterprise system 200. The computing environment 100 may include, for example, a distributed cloud computing environment (private cloud, public cloud, community cloud, and/or hybrid cloud), an on-premise environment, fog- computing environment, and/or an edge-computing environment. The user 110 accesses services and products of the enterprise system 200 by use of one or more user devices, illustrated in separate examples as 104, 106. Example user devices 104, 106 may include a laptop, desktop computer, tablet, a mobile computing device such as a smart phone, a portable digital assistant (PDA), a pager, a mobile television, a gaming device, an audio/video player, a virtual assistant device or other smart home device, a wireless personal response device, or any combination of the aforementioned, or other portable device with processing and communication capabilities.

In the illustrated example, the mobile device 106 is illustrated in FIG. 1 as having exemplary elements, the below descriptions of which apply as well to the computing device 104. The user device 104, 106 can include integrated software applications that manage device resources, generate user interfaces, accept user inputs, and facilitate communications with other devices among other functions. The integrated software applications can include an operating system, such as Linux®, UNIX®, Windows®, macOS®, iOS®, Android®, or other operating system compatible with personal computing devices. Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system used on personal computers, central computing systems, phones, and other devices.

The user 110 can be any individual, a group, entity, etc. that is in possession of or has access to the user device 104, 106, which may be personal or public items. Although the user 110 may be singly represented in some figures, in at least in some embodiments the user 110 is one of many such that a group of users through multiple user devices utilize the computing environment 100 to communicate with the enterprise system 200.

The user device 104, 106, but as illustrated with reference to the mobile device 106, includes components such as, at least one of each of a processor 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processor 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user, or required or related to any or all of the applications or programs 130.

The memory device 122 is operatively coupled to the processor 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory additionally or alternatively can include an electrically erasable programmable read-only memory (EEPROM), flash memory or the like.

According to various embodiments, the memory device 122 and storage device 124 may be combined into a single storage medium. The memory device 122 and storage device 124 can store any of a number of applications that comprise computer-executable instructions and code executed by the processing device 120 to implement the functions of the user device 104, 106 described herein. For example, the memory device 122 may include such applications as a conventional web browser application and/or an enterprise-distributed application (e.g., a mobile application), collectively referred to herein as a “web portal”. These applications also typically provide a graphical user interface (GUI) on the display 140 that allows the user 110 to communicate via the user device 104, 106 with, for example, an enterprise system 200, and/or other devices or systems. For instance, the GUI on the display 140 may include features for displaying information and accepting inputs from users, and may include fillable text boxes, data fields, hyperlinks, pull down menus, check boxes, and the like.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices may include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may include a camera 146, such as a digital camera.

Further non-limiting examples of input devices and/or output devices of the input and output system 136 may include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

According to one embodiment, the input and output system 136 may include an optical instrument (e.g., camera 146) configured to capture an image. For instance, the optical instrument may include one or more lenses and one or more image sensors (e.g., a charge coupled device (CCD) sensor) configured to convert photons into an electrical signal. For example, pixels of each the image sensors may each include a photodiode (e.g., a semiconductor) that becomes electrically charged in accordance with the strength of the light that strikes the photodiode, where the electrical charge is then relayed to be converted to an electrical signal. In one embodiment, a series of pulses may be applied to the one or more image sensors to relay the accumulate charges within each photodiode in succession down a row of photodiodes to an edge of the respective image sensor. Other optical instrument functionalities are also contemplated herein.

In one embodiment, the input and output system 136 may also be configured to obtain and process various forms of authentication to obtain authentication information of a user 110 in order to provide, for example, access to a specific web portal of the enterprise system 200. For instance, the web portal may be accessed based on the user providing authentication information to log in to the web portal in order to perform various functionalities described herein. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a Global Positioning System (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138 (e.g., system bus), connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, short message service (SMS), enterprise messaging service (EMS), multimedia messaging service (MMS) messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS may be included for navigation and location-related data exchanges, ingoing and/or outgoing. Communications may also or alternatively be conducted via the connector 154 for wired connections such as by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

Computing environment 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, a single system or server may provide the functions of one or more systems, servers, or illustrated components. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more human agents 210, and as an input device by providing virtual buttons, selectable options, a virtual keyboard, and other indicia that, when touched or activated, control or prompt the agent device 212 by action of the human agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

The computing system 206 may have various components similar to the user device 104, 106. For instance, in one example the computing system 206 may include at least one of each of a processing device 220, and a memory device 222 for use by the processing device 220, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data and files, such as those for user accounts, user profiles, enterprise data, files downloaded or received from other devices, and other data items preferred by the user and/or enterprise or required or related to any or all of the applications or programs 230.

As illustrated, the computing system 206 includes an input/output system 236, which generally refers to, includes, and/or is operatively coupled with agent devices 212 and automated system(s) 214, as well as various other input and output devices. According to various embodiments, the computing system 206 may be used to distribute the digital data collection program as, for example a Software-as-a-Service (SaaS) that can be accessed by the user device 104, 106 on a subscription basis via a web browser or mobile application. SaaS may provide a user 110 with the capability to use applications running on a cloud infrastructure of the enterprise system 200, where the applications are accessible using the user device 104, 106 via a thin client interface such as a web browser and the user 110 is not permitted to manage or control the underlying cloud infrastructure (i.e., network, servers, operating systems, storage, or specific application capabilities that are not user-specific) of the enterprise system 200.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high- speed interface connecting the processing device 220 to the memory device 222, individual electrical connections among the components, and electrical conductive traces on a motherboard common to some or all of the above-described components of the user device 104, 106.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, near-field communication device, and other transceivers. In addition, GPS may be included for navigation and location-related data exchanges, ingoing and/or outgoing. Communications may also, or alternatively, be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing system 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices 104, 106, the agent devices 212, computing system 206, which may be one or any number centrally located or distributed, are in communication through one or more networks, referenced as network 258 in FIG. 1.

The network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of this description. In some embodiments, the network 258 may be or provide one or more cloud- based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMAX, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, frames using frame relay, voice, video, data, and other suitable information between network addresses. The network 258 may also include one or more local area networks (LANs), radio access networks (RANs), metropolitan area networks (MANs), wide area networks (WANs), personal area networks (PANs), WLANs, campus area network (CAN), storage-area network (SAN), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, third-party PaaS, third-party IaaS, external databases, business entities, banking systems, enterprises, organizations, institutions, companies, government entities, clubs, and groups of any size are all within the scope of the description. According to various embodiments, external systems 202 and 204 may utilize software applications that function using external resources that are available through a third-party provider such as SaaS, PaaS, or IaaS service models. Such external systems 202, 204 include the third party systems accessible via the agent devices 212 using a software application (e.g., an integrated mobile software application or an application programming interface (API) software application) that can be integrated with the computing system 206 to facilitate communication between software and systems and also configured to utilize different data formats between systems. In another embodiment, the third party system may be accessible by the agent devices 212 using a web-based software interface (e.g., a website).

In certain embodiments, one or more of the systems described herein such as the user device (referring to either or both of the computing device 104 and the mobile device 106), the enterprise system 200, and/or the external systems 202 and 204 are, include, or utilize virtual resources. Such virtual resources are or include cloud resources or virtual machines. The virtual resources may utilize a cloud-computing configuration to provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud-computing configuration so that the resources may be shared as needed.

Existing processes that customers use to obtain foreign currency are inadequate and can cause dissatisfaction with customers. Traditionally, business entities such as banks or other financial institutions have been used by customers to exchange a resource such as currency from one regional entity (i.e., country) to a resource of one or more foreign regional entities (i.e., foreign countries). Often, customers will visit a local bank branch location and ask for resources (e.g., cash, an amount from a savings or checking account, etc.) to be exchanged to a foreign currency. Customers may have an upcoming trip to a foreign country or a certain transaction may require a foreign currency, which leads the customers to seek out the foreign currency. However, not all local bank branch locations have on-hand foreign currency that can be readily exchanged. For example, if a customer visits their local bank branch in Mooresville, North Carolina in the United States and asks for the teller to provide them with 10,000 Indian Rupee (INR) in exchange for a certain amount of U.S. dollars, the local bank branch may not typically have Indian Rupee available for exchange, or the local bank branch may only have 5,000 Indian Rupee on hand at a given time. At that point, the customer may either ask the teller to order the 10,000 Indian Rupees from a resource distribution facility in Arlington, Virginia or try to find another bank or business that would have 10,000 Indian Rupees on hand in order to make the currency exchange. It may be that the closest bank branch that has 10,000 Rupees on-hand is in Huntersville, North Carolina in the United States, which is a relatively short driving distance from Mooresville, North Carolina. If the customer was aware of the 10,000 Rupees on-hand in Huntersville that could be accessed relatively quickly (e.g., within an hour) if they drove to Huntersville, the customer may choose to drive to the bank branch in Huntersville, North Carolina. However, the local branch in Mooresville may not have any information or knowledge about what foreign currency is on hand at the local branch in Huntersville, North Carolina and the standard ordering process would take 3-5 business days for the foreign currency to arrive from the resource distribution facility in Arlington, Virginia. Thus, the existing system is inefficient and can be inconvenient for customers. In another scenario, customers may call ahead to ask if their local bank branch has 10,000 Indian Rupees on hand; but, again, if the local bank branch does not have the 10,000 Indian Rupees then the customer may have to call around to other banks or request that their local bank branch order the 10,000 Indian Rupees from the resource distribution facility in Arlington, Virginia. Thus, a need exists for an improved customer experience that will help customers best identify locations where they can make the desired currency exchange and how quickly the customer can obtain the foreign currency at the identified locations.

Disclosed herein are systems and methods that allow a customer to access the website of their bank or financial institution and place an online order to pick up the foreign currency from a specific branch location. Providing the customer with information about where the foreign currency can be obtained and how quickly the foreign currency would be available at the locations would help customers decide what option works best for their individual circumstance. Some customers may have an unexpected or emergency trip to a foreign country and may need the foreign currency quickly without ordering the foreign currency from a resource distribution facility. The disclosed system would provide customers with a way to identify a plurality of branch pickup locations within a specified radius (e.g., 25 mile radius of Mooresville, North Carolina), United States where the foreign currency exchange could take place and the amount of time it would take in order for the foreign currency to be available in the quantity requested.

For example, if a customer were to access the online entity platform or webpage of a bank and initiate a process to order a foreign currency, the system could access a relational database management system that tracks on-hand inventory of foreign currency at all of the branch locations within a general regional location (e.g., a desired radius of the customer's current geolocation, a desired radius from a postal code, within view of a map depicted on the customer's computing device, etc.). In some embodiments, a GPS may be used to triangulate or otherwise approximate the location of the customer's computing device based on satellite signals. For example, a GPS receiver in the customer's computing device may receive signals from four or more GPS satellites, and the GPS receiver can derive the computing device's location by measuring the time it takes for each signal to arrive at the customer's computing device. The satellite signals may include unique pseudo-random noise codes, satellite positioning data, and absolute time information. The GPS receiver may include a GPS system of the computing device may include a GPS antenna, a GPS receiver, a microprocessor, and a wireless communication transceiver. The system could then indicate which branch locations have on-hand inventory that are within the general regional location in the quantity of the foreign currency that the customer inputs into one or more control inputs via the webpage. In addition, the system could also indicate how long it would take for each of the branch locations to obtain the desired foreign currency. In one embodiment, a user interface of the computing device may display a visual representation on a map of the computing device's current geolocation as derived using the GPS system relative the various branch locations where the foreign currency exchange can occur. One branch location may already have the desired foreign currency on hand; another branch location may already have a scheduled delivery arriving tomorrow; other branch locations that are more remote or in smaller towns may have preset days that they receive orders for foreign currency; or some branch locations may allow for expedited shipping of foreign currency for a fee. Various other scenarios for obtaining the foreign currency are also contemplated herein.

Advantageously, in some embodiments, the system may sort a list of local branch locations based on various sorting criteria. For example, the user may provide an input to sort the list of local branch locations based on distance from the customer's current geolocation, based on an amount of time it would take for a branch location within the general regional location to obtain the foreign currency, based on business hours at the local branch locations, etc. In one example, the system may receive, via a user interface, a customer selection to organize a list of branch locations displayed on the user interface based on a specific criteria, where the specific criteria is a time it would take to obtain the amount of the foreign currency needed by the customer. A processor would then determine a distance of each branch location and the period of time it would take each of the branch locations to obtain the amount of foreign currency needed by the customer, and the results depicted by the list of branch locations would automatically repopulate with the branch location with the shortest wait time to obtain the amount of foreign currency and the closes distance from the customer's device so that the customer can provide an order input selecting a pickup location to pick up the foreign currency. This provides a specific improvement of prior systems, which results in an improved user interface for electronic devices in order to order foreign currency. Further, the act of determining the distance from the customer's device requires calculation by the GPS receiver of the customer's computing device to calculate distances of each of the branch locations from the computing device's current geolocation, which cannot be practically performed in the human mind as it requires calculating time needed for satellite signals to reach the customer's computing device.

In some embodiments, if timing is not as essential to the customer and the customer is more interested in picking up the foreign currency from a convenient branch location, the customer could indicate a desired date when they would like the foreign currency to be available at their local branch. In some embodiments, a customer may request a direct order of the foreign currency to be delivered to the customer's address using a commercial parcel carrier.

FIGS. 2A-2B depict a block diagram of an example method 200 to facilitate a resource conversion from a first resource of one regional entity to a second resource of one or more foreign regional entities, in accordance with an embodiment of the present invention. In this example, at block 205 the relational database management system receives, across a network via an entity platform from a computing device, one or more inputs or user selections to access an interface or entity webpage to facilitate a resource conversion from a first resource of one regional entity (i.e., from a currency of one country) to a second resource of one or more foreign regional entities (i.e., to a foreign currency), the entity platform incorporating information of one or more relational database. At block 210, the system initiates displaying, via the entity platform on a user interface of the computing device, an ordering interface to order the second resource of the one or more foreign regional entities (i.e., the foreign currency). At block 215, a selection input of a specific foreign regional entity of the one or more foreign regional entities is received. For example, the user may indicate which country or the type of foreign currency needed. Based on receiving selection of the country or foreign currency type, the system access stored current exchange rate data from the one or more relational databases, the stored current exchange rate data indicating a present exchange rate between the first resource of the one regional entity and the second resource of the specific foreign regional entity (i.e., the exchange rate between one currency to the foreign currency). According to various embodiments, the present exchange rate may be based on market conditions, third-party exchange rates, a desired rate of return that is desired by the entity facilitating the currency exchange, and market risk. For example, some foreign currencies are relatively stable when compared to the U.S. dollar, whereas other foreign currencies dynamically fluctuate in value when compared to the U.S. dollar. The entity that facilitates the foreign currency exchange may incorporate certain safeguards into the exchange rate to ensure that the entity does not realize financial losses because of the foreign currency exchange. In some examples, the entity facilitating the currency exchange may fluctuate the exchange rate, in some cases significantly, in response to market conditions. In some cases, the exchange rate may not reflect the same exchange rates provided by other entities, so there is a formula that is used by the entity to determine what the exchange rate should be at any given time. In some embodiments, the present exchange rate is different from and inferior to a rate that the business entity facilitating the currency exchange is required to pay in order to exchange one resource for another (i.e., a rate applied to a business entity that is used to obtain the second resource of the specific foreign regional entity, the business entity being associated with the entity platform).

At block 220, the system initiates displaying, via the entity platform on the user interface of the computing device, the present exchange rate and one or more control inputs for (a) specifying a quantity of the second resource to be exchanged from the first resource of the one regional entity to the second resource of the specific foreign regional entity, and (b) indicating a general regional location where the second resource of the specific foreign regional entity is to be retrieved. The one or more control inputs can include a drop down menu of selectable countries or types of currency, a text box where the user can type in the type of money desired or the country, radio buttons, selectable buttons/boxes, etc. The control inputs for the general regional location can allow the user to input a city, a postal/zip code, and/or can include a button that the user can select to grant access to the computing device's GPS system so that the entity platform can access current geolocation data of the computing device's current geolocation. The quantity of the second resource to be exchanged would have the current exchange rate applied thereto such that the quantity of the second resource to be exchanged differs from a quantity of the first resource of one regional entity that is provided in exchange for the second resource. In some embodiments, the initiating displaying of the present exchange rate further includes initiating displaying a rounded quantity of the first resource of the one regional entity that would need to be provided by a user at the pickup location and the second resource of the specific foreign regional entity that a business entity would provide at the pickup location in exchange for the rounded quantity of the first resource. In some embodiments, the one or more control inputs have a minimum quantity applied thereto such that the indication of the quantity of the second resource to be exchanged must be greater than or equal to the minimum quantity in order for the indication to be received. The minimum quantity may be a predetermined amount set by a business entity. For example, the business entity may specify that no foreign currency exchanges be permitted or allowed for amounts less than $100 US dollars. This may ensure that if an order is placed for a foreign currency that it is cost effective for the business entity to process the foreign currency exchange. In some embodiments, the one or more control inputs may have a maximum quantity applied thereto such that the indication of the quantity of the second resource to be exchanged must be lower than the maximum quantity in order for the indication to be received. The maximum quantity may be a predetermined amount set by a business entity. This maximum quantity threshold may ensure that banks do not facilitate currency exchange at a level that would influence market manipulation or cause money-laundering concerns. For example, the business entity may set the maximum quantity threshold at $10,000 US dollars within a certain time period (e.g., within one day, one week, one month, etc.) to try to limit nefarious activity.

At block 225, the system receives, via the one or more control inputs, an indication of the quantity of the second resource to be exchanged and the general regional location where the second resource of the specific foreign regional entity is to be retrieved. The indication may, according to some embodiments, filter the results of the general regional location. For example, the user may specify that they want to find locations within a 10-mile radius, 25-mile radius, 50-mile radius, etc. of their current location (i.e., their electronic device's current location). In order to determine the electronic device's current location, the user would need to grant access to the entity platform to retrieve stored geolocation data on the user's computing device. The stored geolocation data can include current geolocation data that indicates a current geolocation of the computing device. At block 230, the system performs data processing on resource data that indicate on-hand resource quantities of the second resource of the specific foreign regional entity at a plurality of entity pickup locations. At block 235, the system ascertains processing times for the quantity of the second resource to be exchanged to be transported to targeted pickup locations of the plurality of entity pickup locations that are within the general regional location where the second resource of the specific foreign regional entity is to be retrieved. At block 240, the system generates and initiates displaying, via the entity platform on the user interface of the computing device, a list of the targeted pickup locations where the second resource of the specific foreign regional entity can be retrieved and a corresponding earliest available time when the second resource of the specific foreign regional entity would be available for retrieval at each of the targeted pickup locations, the corresponding earliest available time being based on the on-hand resource quantities and the ascertained processing times. At block 245, the system receives, from the computing device, an order input indicating a pickup location from the list of the targeted pickup locations where the quantity of the second resource to be exchanged is to be picked up.

In some embodiments, when a customer has an existing bank account with the entity facilitating the currency exchange, an amount in the customer's account may be designated and blocked from being withdrawn (i.e., a hold would be placed on the funds) once the order for the foreign currency has been placed. In addition, if a customer orders foreign currency, the customer may be able to designate a pickup date. However, if the customer does not actually pick up the foreign currency within a preset period of time (e.g., five business days) of the designated pickup date, the entity facilitating the foreign currency exchange may stop placing a hold on the customer's funds in their account and may be able to issue the foreign currency to other customers. A new order would then need to be placed for the foreign currency. In instances where an order is placed on a weekend or holiday, the amount requested and the exchange rate quoted for the order will be the exchange rate applied regardless of whether the exchange rate changes during the weekend or after the holiday. Similarly, in instances where the customer orders foreign currency on one day and it takes several days for the foreign currency to be shipped to a pickup location, the exchange rate that applied when the order was placed would apply, even if the exchange rate is different on the day the customer actually picks up the foreign currency from the pickup location.

The entity facilitating the currency exchange may have different policies for existing customers than for individuals who are not existing customers. For example, the entity may be able to place a hold on funds in a bank account of an existing customer, whereas the entity would not be able to hold funds if the individual is not an existing customer. Thus, if a foreign currency needs to be ordered, certain shipping fees or processing fees may apply to individuals who are not existing customers.

In some embodiments, the method 200 may also include initiating displaying an authentication interface configured to receive authentication information of a user. Further, the method 200 includes receiving user authentication information to authenticate the user in order to realize or effectuate the order input received. The method also includes authenticating the received user authentication information by comparing the received user authentication information to stored authentication information of entity customers. Based on successfully authenticating the received user authentication information, the method 200 also includes allocating the quantity of the second resource to be exchanged at the pickup location. In some embodiments, the allocating includes determining whether the quantity of the second resource to be exchanged is greater than an on-hand resource quantity of the second resource at the pickup location, and based on the quantity of the second resource being greater initiating a physical resource transfer of a difference of the on-hand resource quantity of the second resource and the quantity of the second resource to be exchanged, the physical resource transfer including shipping the difference to the pickup location. In some embodiments, the difference that is being shipped is shipped from one or more of the targeted pickup locations. In other embodiments, the difference that is being shipped is from a closest physical location of the one or more of the targeted pickup locations. In some embodiments, the shipping of the difference is from a resource distribution facility that houses resources of the one or more foreign regional entities.

FIGS. 3A and 3B depict a block diagram of an example method 300 for data retrieval, in accordance with an embodiment of the present invention. At block 305, the system transmits, across a network via an entity platform, one or more control signals to an entity system from a computing device, the one or more control signals requesting access to an interface to facilitate a resource conversion from a first resource of one regional entity to a second resource of one or more foreign regional entities (i.e., a foreign currency exchange), where the entity platform incorporates information of one or more relational databases in order to perform the foreign currency exchange. At block 310, the computing device receives one or more responses from the entity system and based thereon displays, on a user interface, an ordering interface to order the second resource of the one or more foreign regional entities. At block 315, the computing device processes a selection input indicating a specific foreign regional entity of the one or more foreign regional entities displayed by the ordering interface, and based thereon transmit selection data of the specific foreign regional entity to the entity system.

At block 320, the computing device receives, from the entity system, and displays, via the user interface, a present exchange rate and one or more control inputs for (a) specifying a quantity of the second resource to be exchanged from the first resource of the one regional entity to the second resource of the specific foreign regional entity, and (b) indicating a general regional location where the second resource of the specific foreign regional entity is to be retrieved. At block 325, the computing device receives, via the one or more control inputs, and transmit, to the entity system, an indication of the quantity of the second resource to be exchanged and the general regional location where the second resource of the specific foreign regional entity is to be retrieved.

At block 330, the computing device ascertains, using a GPS system, the computing device's current geolocation by receiving satellite signals from multiple satellites, and current geolocation data of the current geolocation are transmitted to the entity system. At block 335, the computing device receives targeted pickup location data an displays, via the user interface, a list of targeted pickup locations where the second resource of the specific foreign regional entity can be retrieved as well as a corresponding earliest available time when the second resource of the specific foreign regional entity would be available for retrieval at each of the targeted pickup locations, the corresponding earliest available time being based on on-hand resource quantities and processing times, the targeted pickup locations being within a defined distance of the current geolocation. At block 340, the computing device receives, via the user interface, and transmits, to the entity system, an order input indicating a pickup location from the list of the targeted pickup locations where the quantity of the second resource to be exchanged is to be picked up.

In some embodiments, the method 300 also includes displaying, via the user interface, an authentication interface configured to receive authentication information of a user. The method 300 may also include obtaining and transmitting user authentication information to the entity system to authenticate the user in order to realize or effectuate the order input received. The method 300 may also include displaying a confirmation interface confirming the order has been effectuated. For example, once the order has been placed, the user interface will display a confirmation number, an order pickup date, an order pickup location, the quantity of the first resource that is being placed on hold from the customer's bank account, and the amount of the foreign currency that will be available to the user as part of the currency exchange.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®”, “Windows®”, “macOS®”, “iOS®”, “Android®”, and the like may be subject to trademark rights in various jurisdictions throughout the world and are used here only in reference to the products or services properly denominated by the marks to the extent that such trademark rights may exist.

What is claimed is:

1. A relational database management system of data structures facilitating file management and data retrieval, the system comprising:
at least one processor;
a communication interface communicatively coupled to the at least one processor; and
a memory device storing executable code that, when executed, causes the at least one processor to:
receive, across a network via an entity platform from a computing device, one or more inputs to access an interface to facilitate a resource conversion from a first resource of one regional entity to a second resource of one or more foreign regional entities, the entity platform incorporating information of one or more relational database;
initiate displaying, via the entity platform on a user interface of the computing device, an ordering interface to order the second resource of the one or more foreign regional entities;
receive a selection input of a specific foreign regional entity of the one or more foreign regional entities, and based thereon access stored current exchange rate data from the one or more relational databases, the stored current exchange rate data indicating a present exchange rate between the first resource of the one regional entity and the second resource of the specific foreign regional entity;
initiate displaying, via the entity platform on the user interface of the computing device, the present exchange rate and one or more control inputs for (a) specifying a quantity of the second resource to be exchanged from the first resource of the one regional entity to the second resource of the specific foreign regional entity, and (b) indicating a general regional location where the second resource of the specific foreign regional entity is to be retrieved;
receive, via the one or more control inputs, an indication of the quantity of the second resource to be exchanged and the general regional location where the second resource of the specific foreign regional entity is to be retrieved;
perform data processing on resource data that indicate on-hand resource quantities of the second resource of the specific foreign regional entity at a plurality of entity pickup locations;
ascertain processing times for the quantity of the second resource to be exchanged to be transported to targeted pickup locations of the plurality of entity pickup locations that are within the general regional location where the second resource of the specific foreign regional entity is to be retrieved;
generate and initiate displaying, via the entity platform on the user interface of the computing device, a list of the targeted pickup locations where the second resource of the specific foreign regional entity can be retrieved and a corresponding earliest available time when the second resource of the specific foreign regional entity would be available for retrieval at each of the targeted pickup locations, the corresponding earliest available time being based on the on-hand resource quantities and the ascertained processing times; and
receive, from the computing device, an order input indicating a pickup location from the list of the targeted pickup locations where the quantity of the second resource to be exchanged is to be picked up.

2. The system of claim 1, wherein the present exchange rate is based on market conditions, third-party exchange rates, a desired rate of return, and market risk.

3. The system of claim 1, wherein the present exchange rate is different from and inferior to a rate applied to a business entity that is used to obtain the second resource of the specific foreign regional entity, the business entity being associated with the entity platform.

4. The system of claim 1, wherein the present exchange rate is applied to the quantity of the second resource to be exchanged such that the quantity of the second resource to be exchanged differs from a quantity of the first resource of one regional entity that is provided in exchange for the second resource.

5. The system of claim 1, wherein the initiating displaying of the present exchange rate further includes initiating displaying a rounded quantity of the first resource of the one regional entity that would need to be provided by a user at the pickup location and the second resource of the specific foreign regional entity that a business entity would provide at the pickup location in exchange for the rounded quantity of the first resource.

6. The system of claim 1, wherein the executable code, when executed, further causes the at least one processor to:
initiate displaying an authentication interface configured to receive authentication information of a user;
receive user authentication information to authenticate the user in order to effectuate the order input received;
authenticate the received user authentication information by comparing the received user authentication information to stored authentication information of entity customers; and
based on successfully authenticating the received user authentication information, allocate the quantity of the second resource to be exchanged at the pickup location.

7. The system of claim 6, wherein the allocating includes determining whether the quantity of the second resource to be exchanged is greater than an on-hand resource quantity of the second resource at the pickup location, and based on the quantity of the second resource being greater initiating a physical resource transfer of a difference of the on-hand resource quantity of the second resource and the quantity of the second resource to be exchanged, the physical resource transfer including shipping the difference to the pickup location.

8. The system of claim 7, wherein the shipping of the difference is from one or more of the targeted pickup locations.

9. The system of claim 7, wherein the shipping of the difference is from a closest physical location of the one or more of the targeted pickup locations.

10. The system of claim 7, wherein the shipping of the difference is from a resource distribution facility that houses resources of the one or more foreign regional entities.

11. The system of claim 1, wherein the one or more control inputs have a minimum quantity applied thereto such that the indication of the quantity of the second resource to be exchanged must be higher than the minimum quantity in order for the indication to be received, wherein the minimum quantity is a predetermined amount set by a business entity.

12. The system of claim 1, wherein the one or more control inputs have a maximum quantity applied thereto such that the indication of the quantity of the second resource to be exchanged must be lower than the maximum quantity in order for the indication to be received, wherein the maximum quantity is a predetermined amount set by a business entity.

13. A computing system for data retrieval, the computing system comprising:
at least one processor;
a communication interface communicatively coupled to the at least one processor; and
a memory device storing executable code that, when executed, causes the at least one processor to:
transmit, across a network via an entity platform, one or more control signals to an entity system from a computing device, the one or more control signals requesting access to an interface to facilitate a resource conversion from a first resource of one regional entity to a second resource of one or more foreign regional entities, the entity platform incorporating information of one or more relational databases;
receive, by the computing device, one or more responses from the entity system and based thereon display, on a user interface, an ordering interface to order the second resource of the one or more foreign regional entities;
process, by the computing device, a selection input indicating a specific foreign regional entity of the one or more foreign regional entities displayed by the ordering interface, and based thereon transmit selection data of the specific foreign regional entity to the entity system;
receive, from the entity system, and display, via the user interface of the computing device, a present exchange rate and one or more control inputs for (a) specifying a quantity of the second resource to be exchanged from the first resource of the one regional entity to the second resource of the specific foreign regional entity, and (b) indicating a general regional location where the second resource of the specific foreign regional entity is to be retrieved;
receive, via the one or more control inputs, and transmit, to the entity system, an indication of the quantity of the second resource to be exchanged and the general regional location where the second resource of the specific foreign regional entity is to be retrieved;
ascertain, using a GPS system of the computing device, a current geolocation of the computing device and transmit current geolocation data of the current geolocation to the entity system;
receive targeted pickup location data and display, via the user interface, a list of targeted pickup locations where the second resource of the specific foreign regional entity can be retrieved and a corresponding earliest available time when the second resource of the specific foreign regional entity would be available for retrieval at each of the targeted pickup locations, the corresponding earliest available time being based on on-hand resource quantities and processing times, the targeted pickup locations being within a defined distance of the current geolocation; and
receive, via the user interface, and transmit, to the entity system, an order input indicating a pickup location from the list of the targeted pickup locations where the quantity of the second resource to be exchanged is to be picked up.

14. The computing system of claim 13, wherein the present exchange rate is based on market conditions, third-party exchange rates, a desired rate of return, and market risk.

15. The computing system of claim 13, wherein the present exchange rate is different from and inferior to a rate applied to a business entity that is used to obtain the second resource of the specific foreign regional entity, the business entity being associated with the entity platform.

16. The computing system of claim 13, wherein the present exchange rate is applied to the quantity of the second resource to be exchanged such that the quantity of the second resource to be exchanged differs from a quantity of the first resource of one regional entity that is provided in exchange for the second resource.

17. The computing system of claim 13, wherein the executable code, when executed, further causes the at least one processor to:
display, via the user interface, an authentication interface configured to receive authentication information of a user;
obtain and transmit user authentication information to the entity system to authenticate the user in order to effectuate the order input received; and
display a confirmation interface confirming the order has been effectuated.

18. A computer-implemented method, comprising:
receiving, across a network via an entity platform from a computing device, one or more inputs to access an interface to facilitate a resource conversion from a first resource of one regional entity to a second resource of one or more foreign regional entities, the entity platform incorporating information of one or more relational databases;
initiating display, via the entity platform on a user interface of the computing device, of an ordering interface to order the second resource of the one or more foreign regional entities;
receiving a selection input of a specific foreign regional entity of the one or more foreign regional entities, and based thereon access stored current exchange rate data from the one or more relational databases, the stored current exchange rate data indicating a present exchange rate between the first resource of the one regional entity and the second resource of the specific foreign regional entity;
initiating display, via the entity platform on the user interface of the computing device, of the present exchange rate and one or more control inputs for (a) specifying a quantity of the second resource to be exchanged from the first resource of the one regional entity to the second resource of the specific foreign regional entity, and (b) indicating a general regional location where the second resource of the specific foreign regional entity is to be retrieved;
receiving, via the one or more control inputs, an indication of the quantity of the second resource to be exchanged and the general regional location where the second resource of the specific foreign regional entity is to be retrieved;
performing data processing on resource data that indicate on-hand resource quantities of the second resource of the specific foreign regional entity at a plurality of entity pickup locations;
ascertaining processing times for the quantity of the second resource to be exchanged to be transported to targeted pickup locations of the plurality of entity pickup locations that are within the general regional location where the second resource of the specific foreign regional entity is to be retrieved;
generating and initiating display, via the entity platform on the user interface of the computing device, of a list of the targeted pickup locations where the second resource of the specific foreign regional entity can be retrieved and a corresponding earliest available time when the second resource of the specific foreign regional entity would be available for retrieval at each of the targeted pickup locations, the corresponding earliest available time being based on the on-hand resource quantities and the ascertained processing times; and
receiving, from the computing device, an order input indicating a pickup location from the list of the targeted pickup locations where the quantity of the second resource to be exchanged is to be picked up.

19. The computer-implemented method of claim 18, wherein the method further includes:
initiating display of an authentication interface configured to receive authentication information of a user;
receiving user authentication information to authenticate the user in order to effectuate the order input received;
authenticating the received user authentication information by comparing the received user authentication information to stored authentication information of entity customers; and
based on successfully authenticating the received user authentication information, allocating the quantity of the second resource to be exchanged at the pickup location.

20. The computer-implemented method of claim 19, wherein the allocating includes determine whether the quantity of the second resource to be exchanged is greater than an on-hand resource quantity of the second resource at the pickup location, and based on the quantity of the second resource being greater initiating a physical resource transfer of a difference of the on-hand resource quantity of the second resource and the quantity of the second resource to be exchanged, the physical resource transfer including shipping the difference to the pickup location.
